(19) United States
(12) Patent Application Publication
(10) Pub. No.: US 2026/0277007 A1
(43) Pub. Date: Sep. 17, 2026

(54) ADJUSTABLE ASSEMBLIES FOR HEAD-MOUNTABLE DEVICES

(71) Applicant: Apple Inc., Cupertino, CA (US)

(72) Inventors: Paul X. WANG, Cupertino, CA (US); Samuel A. MILLER, Saratoga, CA (US); Trevor J. NESS, Santa Cruz, CA (US)

(21) Appl. No.: 19/531,422

(22) Filed: Feb. 5, 2026

Related U.S. Application Data
(60) Provisional application No. 63/773,331, filed on Mar. 17, 2025.

(51) Int. Cl. G02B 27/01; G02B 27/00

(52) U.S. Cl. CPC G02B 27/0176; G02B 27/0093; G02B 27/0172; G02B 2027/0138; G02B 2027/014; G02B 2027/0158; G02B 2027/0161; G02B 2027/0169

(57) ABSTRACT

A head-mountable device can be provided with selected components that are assembled to provide a variety of dimensions (e.g., sizes and shapes) for accommodating different users at different times. By detecting head features of a user and/or an eyewear device, a custom assembly for a head-mountable device can be determined to achieve a preferred fit. The custom assembly can be based on a range of available components and/or adjustable configurations thereof.

### CROSS-REFERENCE TO RELATED APPLICATION

This application claims the benefit of U.S. Provisional Application No. 63/773,331, entitled “ADJUSTABLE ASSEMBLIES FOR HEAD-MOUNTABLE DEVICES,” filed Mar. 17, 2025, the entirety of which is incorporated herein by reference.

### TECHNICAL FIELD

The present description relates generally to head-mountable devices, and, more particularly, to adjustable assemblies for head-mountable devices.

### BACKGROUND

A head-mountable device can be worn by a user to display visual information within the field of view of the user. The head-mountable device can be used as a virtual reality (VR) system, an augmented reality (AR) system, and/or a mixed reality (MR) system. A user may observe outputs provided by the head-mountable device, such as visual information provided on a display. The display can optionally allow a user to observe an environment outside of the head-mountable device. Other outputs provided by the head-mountable device can include audio output and/or haptic feedback. A useray further interact with the head-mountable device by providing inputs for processing by one or more components of the head-mountable device. For example, the user can provide tactile inputs, voice commands, and other inputs while the device is mounted to the user’s head.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a top view of a head-mountable device, according to some embodiments of the present disclosure.

FIG. 2 illustrates a front view of the head-mountable device of FIG. 1, according to some embodiments of the present disclosure.

FIG. 3 illustrates a side view of an electronic device in use to measure features of a user, according to some embodiments of the present disclosure.

FIG. 4 illustrates the electronic device of FIG. 3 displaying an example of a user interface, according to some embodiments of the present disclosure.

FIG. 5 illustrates a front view of a nosepiece for a head-mountable device, the nosepiece being in a first configuration, according to some embodiments of the present disclosure.

FIG. 6 illustrates a front view of the nosepiece of FIG. 5 in a second configuration, according to some embodiments of the present disclosure.

FIG. 7 illustrates a front view of the nosepiece of FIGS. 5 and 6 in a third configuration, according to some embodiments of the present disclosure.

FIG. 8 illustrates a top view of a head engager of a head-mountable device, the arm being in a first configuration, according to some embodiments of the present disclosure.

FIG. 9 illustrates a top view of the head engager of FIG. 8 in a second configuration, according to some embodiments of the present disclosure.

FIG. 10 illustrates a top view of the head engager of FIGS. 8 and 9 in a third configuration, according to some embodiments of the present disclosure.

FIG. 11 illustrates the electronic device of FIG. 3 displaying an example of a user interface, according to some embodiments of the present disclosure.

FIG. 12 illustrates a flow chart for a process having operations for determining and providing an output for assembly of a head-mountable device, according to some embodiments of the present disclosure.

FIG. 13 illustrates a block diagram of an electronic device, in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mounted devices, such as head-mounted displays, headsets, visors, smartglasses, head-up display, etc., can perform a range of functions that are managed by the components (e.g., sensors, circuitry, and other hardware) included with the wearable device. Interactive systems including head-mounted devices can include multiple parts, such as a head-mounted device that supports an electronic device. The head-mounted device and/or the electronic device can provide the user with outputs such as audio and visual information. The head-mounted device and/or the electronic device can also receive inputs from a user.

Many of the functions performed by a head-mountable device are optimally experienced when the components are in their most preferred position and orientation with respect to a user wearing the head-mountable device. For example, the head-mountable device can include a display that visually outputs display-based information toward the eyes of the user. The position and orientation of the displays relative to the eyes depends, at least in part, on how the head-mountable device is positioned on the face of the user. Due to variations in facial features across different users, a given head-mountable device may require a particular arrangement to accommodate an individual user. For example, different users can have different facial features (e.g., face plane slope, forehead size, eye location, nose geometry, ear geometry, etc.). Accordingly, different users may perceive the displayed information differently unless a preferred arrangement is provided. Similarly, different users may perceive the audio output differently due to variations in ear (tragion) and nose anchoring points.

It can be expensive to offer a broad range of head-mountable devices with many variations of size and shape between each. It can also be expensive to provide to each user a head-mountable device that is entirely customized. It can be desirable to provide to each individual user a head-mountable device that has a tailored arrangement of adjustable parts to fit the user’s features based on a limited number of base designs.

Systems of the present disclosure can provide a head-mountable device with custom components that are assembled to provide a variety of dimensions (e.g., sizes and shapes) for accommodating different users at different times. By detecting head features of a user and/or an eyewear device, a custom assembly for a head-mountable device can be determined to achieve a preferred fit. The custom assembly can be based on a range of available components and/or adjustable configurations thereof.

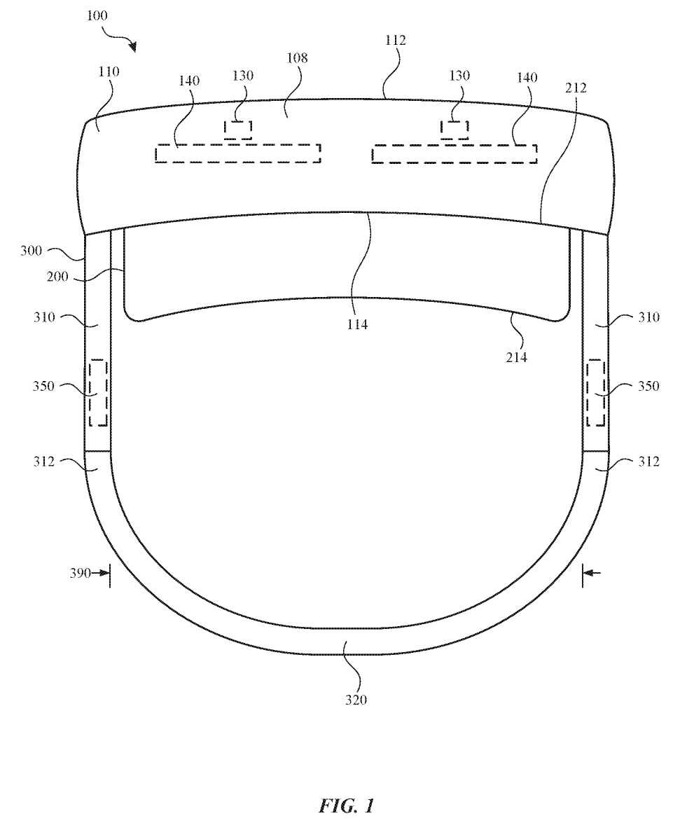

These and other embodiments are discussed below with reference to FIGS. 1–13. However, those skilled in the art will readily appreciate that the detailed description given herein with respect to these Figures is for explanatory purposes only and should not be construed as limiting.

According to some embodiments, for example as shown in FIG. 1, a head-mountable device 100 includes a frame 110. The frame 110 can be worn on a head of a user. For example, the frame 110 can be positioned in front of the eyes of a user to provide information within a field of view of the user. In some embodiments, the head-mountable device 100 includes a face engager 200.

The frame 110 can be supported on a user’s head with a head engager 300. In some embodiments, the head engager 300 includes one or more (e.g., two) arms 310 extending from opposing sides of the frame 110. The arms 310 can wrap around or extend along opposing sides of a user’s head. In some embodiments, the head engager 300 includes a band 320 connecting the arms 310 to each other. In some embodiments, the band 320 can be omitted, and the arms 310 can define respective terminal ends of the head engager 300. For example, the head engager 300 can optionally include earpieces for wrapping around, engaging with, or resting on a user’s ears. In some embodiments, the arms 310 can each have a first end connected to the frame 110 and/or the face engager 200 and a second end, opposite the first end, that is a free end (e.g., defining a terminal end and/or not connected to another structure). It will be appreciated that other configurations can be applied for securing the head-mountable device 100 to a user’s head. For example, one or more bands, straps, belts, caps, hats, or other components can be used in addition to or in place of the illustrated components of the head engager 300. By further example, the head engager 300 can include multiple components to engage a user’s head. The head engager 300 can extend from the frame 110 and/or the face engager 200.

The head engager 300 can provide a configuration having a corresponding arm dimension. The arm dimension can include a separation distance 390 between multiple (e.g., two) arms 310 and/or end portions 312 of the head engager 300. The arm dimension can be adjusted to accommodate different users, as described further therein.

The frame 110 can provide structure around a peripheral region thereof to support any internal components of the frame 110 in their assembled position. For example, the frame 110 can enclose and support various internal components (including for example integrated circuit chips, processors, memory devices and other circuitry) to provide computing and functional operations for the head-mountable device 100, as discussed further herein. While several components are shown within the frame 110, it will be understood that some or all of these components can be located anywhere within or on the head-mountable device 100. For example, one or more of these components can be positioned within the head engager 300 (e.g., the arms 310 and/or the band 320), the face engager 200, and/or the frame 110 of the head-mountable device 100.

The frame 110 can include and/or support one or more cameras 130. The cameras 130 can be positioned on or near an outer side 112 of the frame 110 to capture images of views external to the head-mountable device 100. As used herein, an outer side of a portion of a head-mountable device is a side that faces away from the user and/or towards an external environment. The captured images can be used for display to the user or stored for any other purpose. Each of the cameras 130 can be movable along the outer side 112. For example, a track or other guide can be provided for facilitating movement of the camera 130 therein.

The head-mountable device 100 can include displays 140 that provide visual output for viewing by a user wearing the head-mountable device 100. One or more displays 140 can be positioned on or near an inner side 114 of the frame 110. As used herein, an inner side 114 of a portion of a head-mountable device is a side that faces toward the user and/or away from the external environment.

A display 140 can transmit light from a physical environment (e.g., as captured by a camera) for viewing by the user. Such a display 140 can include optical properties, such as lenses for vision correction based on incoming light from the physical environment. Additionally or alternatively, a display 140 can provide information as a display within a field of view of the user. Such information can be provided to the exclusion of a view of a physical environment or in addition to (e.g., overlaid with) a physical environment.

As further shown in FIG. 1, the face engager 200 can define an interior space through which light can pass, thereby providing to the user wearing the head-mountable device 100 a view of displays 140 of the frame 110. Such a view can be enhanced by preventing the ingress of light from the external environment and into the face engager 200. While the face engager 200 is shown schematically with a particular size and shape, it will be understood that the size and shape of the face engager 200 (e.g., at the outer side 212 and/or the inner side 214 of the face engager 200), can have a size and shape that accommodates the face of a user wearing the head-mountable device 100. For example, the inner side 214 can provide a shape that generally matches the contours of the user’s face around the eyes of the user. The inner side 214 can be provided with one or more features that allow the face engager 200 to conform to the face of the user to enhance comfort and block light from entering the face engager 200 at the point of contact with the face. For example, the inner side 214 can provide a flexible, soft, elastic, and/or compliant structure. In some embodiments, the face engager 200 is omitted, and the frame 110 engages a user directly (e.g., with one or more nosepieces).

As further shown in FIG. 1, a head-mountable device 100 can be provided with one or more electronic devices 350 for further enhancing functionality of the head-mountable device 100. For example, an electronic device 350 can be positioned at the head engager 300 (e.g., at one or both of the arms 310 and/or the band 320). In some embodiments, electronic device 350 includes speakers. Such speakers can be operated in concert and positioned at locations that enhance the audio output of the combined system. For example, the speakers of the electronic device 350 can be operated to provide spatial audio to the user at or near each of the ears of the user. Further examples of electronic devices 350 include batteries, cameras, microphones, sensors, components for receiving input from a user, components for providing output to a user, display drivers, and the like.

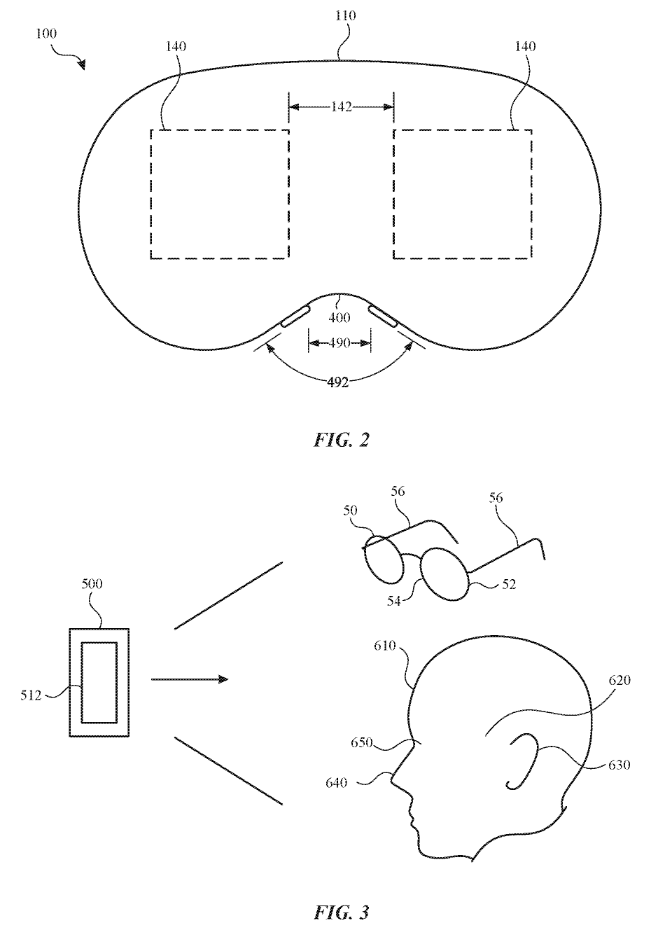

Referring now to FIG. 2, a head-mountable device can include a frame and one or more nosepieces for engaging a nose of a user. As shown in FIG. 2, the head-mountable device 100 can include a nosepiece 400 that engages and/or rests on a nose (and/or cheeks) of a user. For example, while the head-mountable device 100 is worn by a user (e.g., with the head engager against the head of the user), the nosepiece 400 can rest on a nose of the user. In such a configuration, the frame 110, including the display 140, can also be maintained in a fixed location and orientation with respect to the face and head of the user. Given the variety of nose shapes that different users may have, it can be desirable to provide a nosepiece with proper fit capabilities so that the frame 110 is in a desired position and orientation with respect to the face and head of the user during use. In some embodiments, each of multiple nosepieces 400 provides a different separation distance 490 and/or angle 492 for engaging opposing sides of a nose. In some embodiments, a given nosepiece 400 provides an ability to be adjusted to one of multiple available separation distances 490 and/or angles 492 for engaging opposing sides of a nose.

While the nosepiece 400 is shown as mounted to the frame 110, it will be understood that the nosepiece 400 can be mounted indirectly to the frame 110 and/or to another structure, for example at the face engager and/or the head engager. Accordingly, the nosepiece 400 can be directly or indirectly mounted and/or coupled to the frame 110. While a particular nosepiece is shown in FIG. 2, it will be understood that other types of nosepieces can be provided in place of or in addition to the illustrated nosepiece, including those described herein.

The pair of displays 140 can be mounted to the frame 110 and separated by a distance. The distance 142 between the pair of displays 140 can be designed to correspond to the interpupillary distance (“IPD”) of a user. IPD is defined as the distance between the centers of the pupils of a user’s eyes. The distance 142 between the displays 140 be provided to account for different IPDs of different users that may wear the head-mountable device 100.

In some embodiments, either or both of the displays 140 may be movably mounted to the frame 110 to permit the displays 140 to move or translate laterally to make the distance 142 larger or smaller. Any type of manual or automatic mechanism may be used to permit the distance 142 between the displays 140 to be an adjustable distance. For example, the displays 140 can be mounted to the frame 110 via slidable tracks or guides that permit manual or electronically actuated movement of one or more of the displays 140 to adjust the distance 142 there between. By further example, each display 140 can be adjustable to align with a respective eye of the user. For example, each display 140 can be moved along one or more axes until a center of each display 140 is aligned with a center of the respective eye. Accordingly, the distance 142 between the displays 140 can be set based on an interpupillary distance of the user.

In some embodiments, the displays 140 may be fixedly mounted to the frame 110 such that the distance 142 is fixed. A variety of frames 110 can be provided with different distances 142 separating the respective pair of displays 140 thereof. An appropriate frame 110 can be selected based on the distance 142 provided to accommodate the interpupillary distance of the user.

The components of the head-mountable device 100 can be provided with modular configurations that facilitate engagement (e.g., assembly) and release. As used herein, “modular” or “module” can refer to a characteristic that allows an item, such as a face engager, to be connected, installed, removed, swapped, and/or exchanged by a user in conjunction with another item, such as a frame of a head-mountable device. Connection of a frame 110, a face engager 200, a head engager 300, and/or a nosepiece 400 can be performed and reversed, followed by disconnection and connection of another module replacing the prior module. As such, multiple modules can be exchangeable with each other with respect to another module.

Referring now to FIG. 3, a device having a sensor can be operated to detect and/or measure one or more features of a head of a user. Such detections and measurements can be used to determine an assembly of a head-mountable device that will achieve a desired fit with respect to the head of the user.

As shown in FIG. 3, an electronic device 500 or another electronic device can provide a sensor 512 that is operable to measure distances to multiple regions of the face of a user 610. Such regions can include the regions that would be engaged by a frame and/or arms of a head-mountable device when the head-mountable device is worn by the user. For example, the regions can include one or both temples 620, one or both ears 630, a nose 640, and/or one or both eyes 650 of the user 610. By further example, one or more additional regions of the user can be measured, including cheeks, forehead, hair, and the like.

The sensor 512 can include one or more types of sensors. For example, the sensor 512 can include one or more image sensors, depth sensors, thermal (e.g., infrared) sensors, and the like. By further example, a depth sensor can be configured to measure a distance (e.g., range) to an object (e.g., region of the user’s head) via stereo triangulation, structured light, time-of-flight, interferometry, and the like. Additionally or alternatively, the sensor and/or the device can capture and/or process an image based on one or more of hue space, brightness, color space, luminosity, and the like.

In FIG. 3, by way of example, the sensor 512 is depicted as a component of the electronic device 500. The electronic device 500 can be or operate in concert with a portable computing device, a tablet device, a laptop computer, a smartphone, a smart watch, or other appropriate devices that include one or more sensors. The electronic device 500 can be maintained at a fixed location with respect to the user 610, and/or the electronic device 500 can be moved to map different regions of the head of the user 610.

The sensor 512 can measure a distance from the sensor 512 to each of multiple regions of the head of the user 610. In some embodiments, the sensor 512 measures one or more distances to one or both temples 620 of the user 610. Based on such measurements, the distance between the temples 620 can be calculated. Based on the measurements of the temples 620, features (e.g., shape, size, etc.) of the head engager (e.g., arms, bands, and/or earpieces) of a head-mountable device can be determined to accommodate the temples 620 of the user 610 while applying a desired amount of force on the temples 620 of the user 610 to secure the head-mountable device.

In some embodiments, the sensor 512 measures one or more distances to one or both ears 630 of the user 610. Based on such measurements, the location of each of the ears 630 can be determined. Based on the measurements of the ears 630, features (e.g., shape, size, etc.) of the head engager (e.g., arms, bands, and/or earpieces) of a head-mountable device can be determined to accommodate the ears 630 of the user 610 while applying a desired amount of force on the ears 630 of the user 610 to secure the head-mountable device.

In some embodiments, the sensor 512 measures one or more distances to the nose 640 of the user 610. Based on such measurements, the location, shape, size, width, length, and/or angle of the nose 640 can be calculated. Based on the measurements of the nose 640, features (e.g., shape, size, separation distance, angle, etc.) of the frame (e.g., one or more nosepieces at a bridge) of a head-mountable device can be determined to accommodate the nose 640 of the user 610.

In some embodiments, the sensor 512 measures a distance to one or both eyes 650 of the user 610. Based on such measurements, the distance between the eyes 650 (e.g., interpupillary distance) can be calculated. Based on the measurements of the eyes 650, features of the frame of a head-mountable device can be determined to accommodate the eyes 650 of the user 610, for example to place the optical modules at a desired location with respect to the eyes 650.

In some embodiments, the sensor 512 measures any other regions of the head, optionally including portions that are not to be directly engaged by the head-mountable device. Additionally or alternatively, one or multiple distance measurements can be made to each of various regions, such as with respect to multiple sections of one or both temples 620, one or both ears 630, the nose 640, and/or one or both eyes 650 of the user 610.

The sensor 512 can measure one or more contours of the user’s face and/or head surfaces. Such measurements can be used to determine anchor surfaces of one or more portions of the head-mountable device, such as nosepieces, armpieces, earpieces, forehead pieces, and the like. By maximizing the surface area of such components, pressure on the user’s face and/or head can be reduced and comfort can be increased. Additionally, the contours of such components can be formed to match the contours of the face to provide customizable and unique components to increase comfort.

In some embodiments, the electronic device 500 can be operated to detect, measure, and/or analyze eyewear device 50 that is configured to be worn by the user. The eyewear device 50 is different and/or separate from the head-mountable device 100. For example, the eyewear device 50 may be corrective glasses or the like. The location of the eyewear device 50 on the user can provide information about the preferred and/or target engagement regions with the face of the user 610. The electronic device 500 can be maintained at a fixed location with respect to the eyewear device 50, and/or the electronic device 500 can be moved to map different regions of the eyewear device 50. In some embodiments, as shown in FIG. 3, the electronic device 500 is operable to measure the eyewear device 50 while not being worn by the user 610. In addition to making direct measurements of the eyewear device 50 itself, the electronic device 500 can determine the regions of contact between the eyewear device 50 and the user 610. In some embodiments, the electronic device 500 is operable to measure the eyewear device 50 while being worn by the user 610. This can allow the electronic device 500 to make measurements of the eyewear device 50 from sides that might otherwise by blocked by the user 610.

The sensor 512 can measure a distance from the sensor 512 to each of multiple regions of the head of the user 610. In some embodiments, the sensor 512 measures one or more distances to a frame 52 of the eyewear device 50. Based on such measurements, the location, shape, size, width, length, and/or angle of the nose 640 and/or other portions of the user 610 can be estimated. For example, nose engagement portions 54 (e.g., nosepieces) of the frame 52 can be measured while the eyewear device 50 is worn by the user 610 and/or while the eyewear device 50 is not worn by the user. Based on the measurements of the frame 52, features (e.g., shape, size, separation distance, angle, etc.) of the frame (e.g., one or more nosepieces at a bridge) of a head-mountable device can be determined to accommodate the nose 640 of the user 610.

In some embodiments, the sensor 512 measures one or more distances to one or both arms 56 of the eyewear device 50. Based on such measurements, the location, shape, size, width, length, and/or angle of the temples 620 and/or other portions of the user 610 can be estimated. For example, temple and/or ear engagement portions (e.g., temples and/or earpieces) of the arms 56 can be measured while the eyewear device 50 is worn by the user 610 and/or while the eyewear device 50 is not worn by the user. In some embodiments, the measurement of the distance between the arms 56 can be measured while the eyewear device 50 is worn by the user 610 and while the eyewear device 50 is not worn by the user. A difference in the foregoing measurements can used to determine an amount of flexion in the arms 56 while the eyewear device 50 is worn by the user 610. This can be used to determine an amount of force on the temples 620 that is preferred and/or accepted by the user 610. Based on the measurements of the arms 56, features (e.g., shape, size, etc.) of the head engager (e.g., arms, bands, and/or earpieces) of a head-mountable device can be determined to accommodate the temples 620 of the user 610 while applying a desired amount of force on the temples 620 of the user 610 to secure the head-mountable device.

It should be understood that any one or more of the measurements described herein can be taken and combined for an overall determination of the target selection and arrangement of parts for a head-mountable device. Such measurements can be taken in any sequence and across any amount of time.

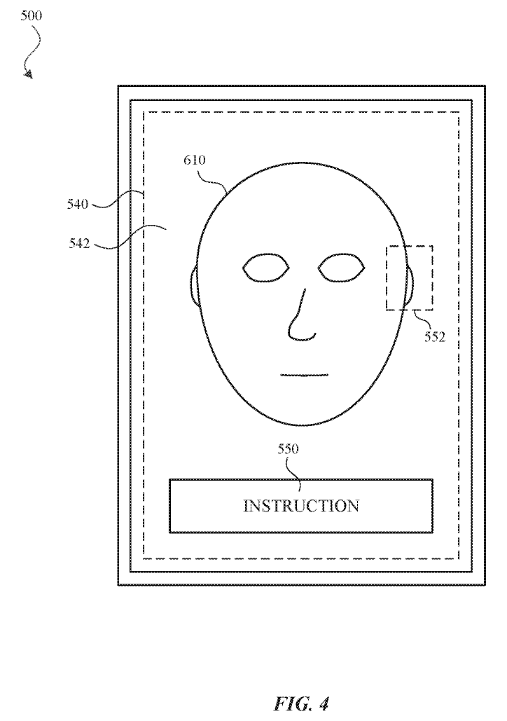

Referring now to FIG. 4, an electronic device can provide a user interface to prompt and/or guide a user during a measurement and/or detection procedure. FIG. 4 illustrates a front view of an electronic device 500 operable by a user, the electronic device 500 providing a user interface 542, according to some embodiments of the present disclosure. In some embodiments, as shown in FIG. 4, a display 540 of the electronic device 500 provides the user interface 542. Not all of the depicted graphical elements may be used in all implementations, however, and one or more implementations may include additional or different graphical elements than those shown in the figure. Variations in the arrangement and type of the graphical elements may be made without departing from the spirit or scope of the claims as set forth herein. Additional components, different components, or fewer components may be provided.

As shown in FIG. 4, the user interface 542 can include one or more visual elements. In some embodiments, the user interface 542 can include one or more guides for assisting one or more users during the measurements and/or detections shown in FIG. 3. For example, the user interface 542 can include a view of the user 610, an eyewear device (not shown), an instruction 550, and/or an indicator 552, such as a selection, box, circle, highlighted region, reticle, crosshairs, point, line, and the like. It will be understood that such visual elements can be provided in addition to other visual elements, such as a view captured by a camera of the electronic device 500. The position of the indicator 552 relative to the user 610 can represent a portion to be measured and/or detected position of the electronic device 500 relative to the user. Where the electronic device 500 is not in a preferred alignment to perform a measurement and/or detection, the instruction 550 and/or the indicator 552 can direct the user through the steps required to obtain the desired measurement and/or detection, such as by moving (e.g., translating and/or rotating) the electronic device 500, moving (e.g., translating and/or rotating) the user 610, moving (e.g., translating and/or rotating) the eyewear device, and/or moving an obstruction (e.g., hair of the user 610, clothing, headwear, another obstacle, and the like).

In some embodiments, the electronic device 500 and/or another device can provide a user interface for inputting information regarding a given user (e.g., user 612). For example, the electronic device 500 and/or another device can include a touchscreen, keyboard, mouse, microphone, camera, and the like. The electronic device 500 and/or another device can present selectable elements (e.g., from a menu) or another input format (e.g., text, handwriting, and the like). The electronic device 500 and/or another device can also include output components, such as a display, speaker, haptic device, and the like. The electronic device 500 and/or another device can be operated by a user (e.g., user 612) and/or another person to input information relating to the user’s head features, personal information, vision correction needs, preferences, and the like. The user can optionally input the user’s own information so that the information is not necessarily made available to another individual. Where the user provides preferences, such preferences can relate to implementation of the assembly of the head-mountable device. For example, the user can select color, shape, style, and/or other features of the head-mountable device. Such selections can be based on a set of available options.

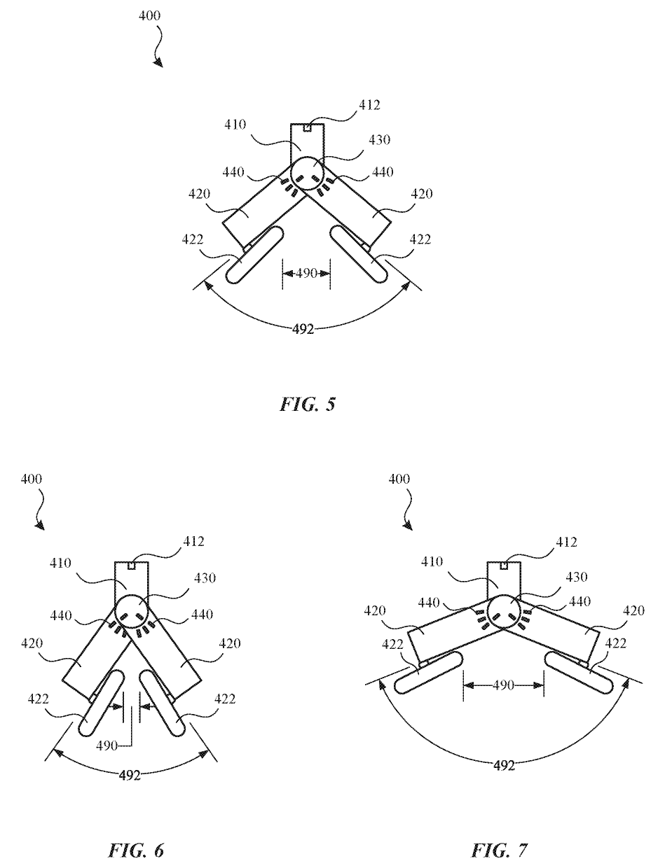

Referring now to FIGS. 5–7, one or more nosepieces for a head-mountable device can provide a variety of different dimensions to accommodate different users wearing the head-mountable device. It should be understood that, in some embodiments, the different dimensions can be provided by multiple nosepieces having respective nosepiece dimensions that are different from each other. It should be understood that, in some embodiments, the different dimensions can be provided by a single nosepiece that is adjustable among multiple configurations, the multiple configurations having respective nosepiece dimensions that are different from each other. As such, the nosepieces of FIGS. 5–7 can represent different nosepieces (e.g., having a static configuration) or a single nosepiece in different configurations.

In some embodiments, as shown in FIG. 5, a nosepiece 400 can include a body 410 that includes an engager 412 to facilitate coupling of the nosepiece 400 to the frame of a head-mountable device. The engager 412 can releasably engage a corresponding engager of the frame. One or more of various mechanisms can be provided to secure the components to each other. For example, mechanisms such as locks, latches, snaps, screws, clasps, threads, magnets, pins, an interference (e.g., friction) fit, knurl presses, bayoneting, and/or combinations thereof can be included to couple and/or secure the nosepiece 400 and the frame together. The components can remain secured to each other until released by a user (e.g., an optional release mechanism is actuated).

In some embodiments, the nosepiece 400 can include one or more extensions 420 that are coupled to the body 410 by a hinge 430 and/or another mechanism that facilitates adjustment. For example, the extensions 420 can be coupled to the body 410 to facilitate rotation and/or translation thereof with respect to the body 410. The extensions 420 can be provided with a range of rotation and/or translation with one or more mechanisms, such as detents 440. In some embodiments, the extensions 420 can be adjusted to a given configuration at any given time. For example, each of the available configurations can be one of multiple discrete adjustment states. The detents 440 can define the discrete adjustment states by providing and maintaining one of multiple (e.g., two, three, four, five, six, greater than six) preferred configurations. The detents 440 can include protrusions, troughs, springs (and/or other biasing mechanisms), magnets, and the like. By further example, each of the available configurations can be along a range of continuous adjustment states.

As further shown in FIG. 5, the nosepiece 400 can provide a configuration having a corresponding nosepiece dimension. The nosepiece dimension can include a separation distance 490 between respective nose engagement portions 422 of the nosepiece 400. Additionally or alternatively, the nosepiece dimension can include an angle 492 formed by the nose engagement portions 422 and/or another portion (e.g., extensions 420) of the nosepiece 400.

In at least one configuration of the nosepiece 400, the separation distance 490 and/or the angle 492 of one configuration (e.g., FIG. 6) can be less than (e.g., smaller than) the separation distance 490 and/or the angle 492 of another configuration (e.g., FIG. 5). In at least one configuration of the nosepiece 400, the separation distance 490 and/or the angle 492 of one configuration (e.g., FIG. 7) can be greater than (e.g., larger than) the separation distance 490 and/or the angle 492 of another configuration (e.g., FIG. 5). While three configurations are shown, it should be understood that any number of configurations can be provided by a single nosepiece 400 and/or by any number of multiple nosepieces 400.

By providing multiple nosepieces and/or nosepieces with an ability to just between multiple configurations, a variety of different nosepiece dimensions can be provided to accommodate the variety and range of nose sizes and nose shapes for different users. By providing a releasable engagement mechanism, different nosepieces can be exchanged for each other to accommodate different users at different times. By providing a range of adjustments, a given nosepiece can provide a range of different sizes to accommodate different users at different times. In some embodiments, different nosepieces can provide different ranges of nosepiece dimensions. For example, a first nosepiece providing a first range of multiple nosepiece dimensions (e.g., a range of smaller dimensions) can be provided, and a second nosepiece providing a second range of multiple nosepiece dimensions (e.g., a range of larger dimensions) can be provided. The appropriate nosepiece and its adjustable configuration can be selected based on measurements and/or detections described herein.

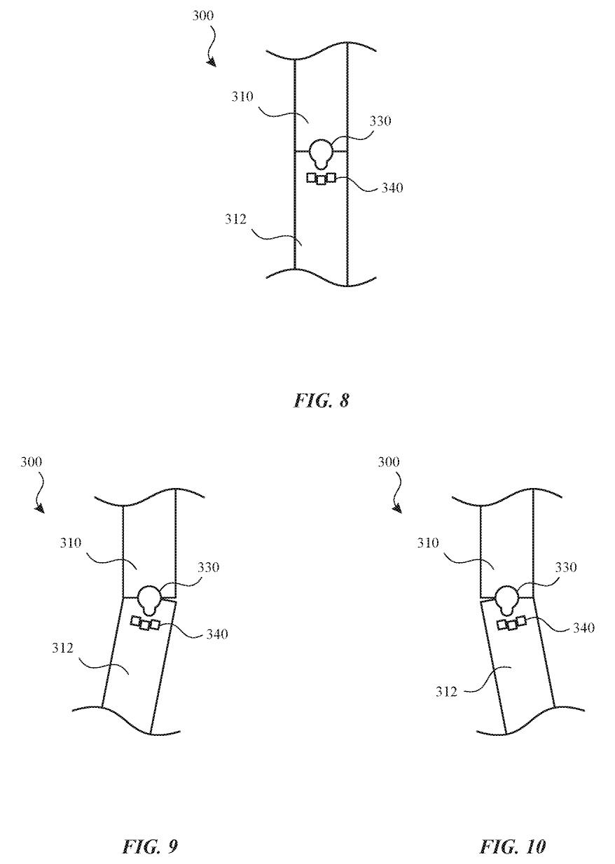

Referring now to FIGS. 8–10, one or more head engagers for a head-mountable device can provide a variety of different dimensions to accommodate different users wearing the head-mountable device. It should be understood that, in some embodiments, the different dimensions can be provided by one or more head engagers that are adjustable among multiple configurations, the multiple configurations having respective arm dimensions that are different from each other. Each of multiple portions (e.g., arms) of a given head engager can be adjusted, with the resulting arm dimension being based on the configuration of both of portions (e.g., arms). As such, the head engagers of FIGS. 8–10 can represent a selected one of multiple (e.g., two) portions (e.g., arms) of a given head engager.

In some embodiments, as shown in FIG. 8, a head engager 300 can include an arm 310 that extends from a frame (not shown) of a head-mountable device. In some embodiments, the head engager 300 can include one or more end portions 312 that are each coupled to a respective arm 310 by a hinge 330 and/or another mechanism that facilitates adjustment. For example, the end portions 312 can be coupled to the arm 310 to facilitate rotation and/or translation thereof with respect to the arm 310. The end portions 312 can be provided with a range of rotation and/or translation with one or more mechanisms, such as detents 340. In some embodiments, each of the end portions 312 can be adjusted to a given configuration at any given time. For example, each of the available configurations can be one of multiple discrete adjustment states. The detents 340 can define the discrete adjustment states by providing and maintaining one of multiple (e.g., two, three, four, five, six, greater than six) preferred configurations. The detents 340 can include protrusions, troughs, springs (and/or other biasing mechanisms), magnets, and the like. By further example, each of the available configurations can be along a range of continuous adjustment states.

The head engager 300 can provide a configuration having a corresponding arm dimension. The arm dimension can include a separation distance 390 between multiple (e.g., two) end portions 312 of the head engager 300 (e.g., shown in FIG. 1).

In at least one configuration of the head engager 300, the separation distance 390 of one configuration (e.g., FIG. 9) can be less than (e.g., smaller than) the separation distance 390 of another configuration (e.g., FIG. 8). In at least one configuration of the head engager 300, the separation distance 390 of one configuration (e.g., FIG. 10) can be greater than (e.g., larger than) the separation distance 390 of another configuration (e.g., FIG. 8). While three configurations are shown, it should be understood that any number of configurations can be provided by a single head engager 300 and/or by any number of multiple head engagers.

By providing head engagers with an ability to just between multiple configurations, a variety of different arm dimensions can be provided to accommodate the variety and range of head sizes and shapes (e.g., at the temples and/or the ears) for different users. By providing a range of adjustments, a given head engager can provide a range of different sizes to accommodate different users at different times. The adjustable configuration of a head engager can be selected based on measurements and/or detections described herein.

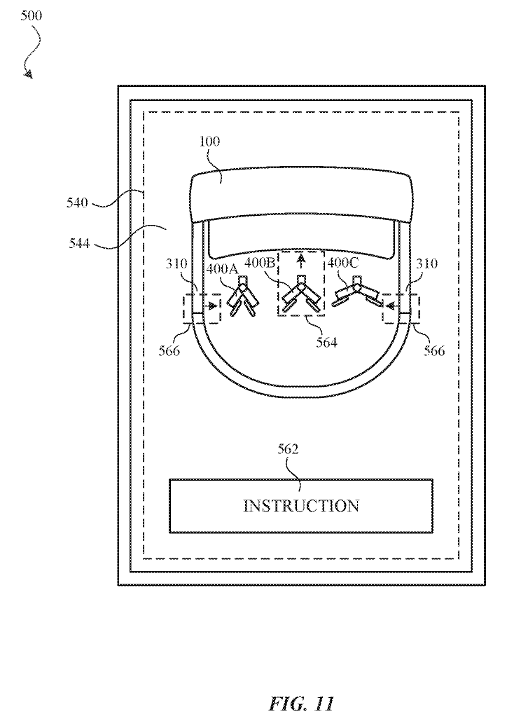

Referring now to FIG. 11, an electronic device can provide a user interface to prompt and/or guide a user during an assembly and/or adjustment procedure. FIG. 11 illustrates a front view of an electronic device 500 operable by a user, the electronic device 500 providing a user interface 544, according to some embodiments of the present disclosure. In some embodiments, as shown in FIG. 11, a display 540 of the electronic device 500 provides the user interface 544. Not all of the depicted graphical elements may be used in all implementations, however, and one or more implementations may include additional or different graphical elements than those shown in the figure. Variations in the arrangement and type of the graphical elements may be made without departing from the spirit or scope of the claims as set forth herein. Additional components, different components, or fewer components may be provided.

As shown in FIG. 11, the user interface 544 can include one or more visual elements. In some embodiments, the user interface 544 can include one or more guides for assisting one or more users during the assembly and/or adjustment of a head-mountable device 100. For example, the user interface 544 can include a view of the head-mountable device 100, one or more nosepieces (e.g., 400A, 400B, and/or 400C), an instruction 562, an indicator 564, and/or an indicator 566, such as a selection, box, circle, highlighted region, reticle, crosshairs, point, line, and the like. It will be understood that such visual elements can be provided in addition to other visual elements, such as a view captured by a camera of the electronic device 500.

In some embodiments, the user interface 544 can include one or more guides for assisting one or more users during selection and/or assembly with respect to a nosepiece. As shown in FIG. 11, the indicator 564 and/or the instruction 562 can indicate to a user a selection of one of multiple nosepieces (e.g., 400A, 400B, and/or 400C). Where one or more nosepieces are captured within a field of view of the electronic device 500, the indicator 564 and/or the instruction 562 can be provided with respect to a selected one (e.g., nosepiece 400B) of the one or more nosepieces for assembly with the head-mountable device 100. Additionally or alternatively, the indicator 564 and/or the instruction 562 can indicate (e.g., by omission) that the other of the one or more nosepieces are not for assembly. In some embodiments, the electronic device 500, based on the determination of which nosepiece is a recommended nosepiece (e.g., based on one or more detections and/or measurements of a head and/or an eyewear device), can identify whether one of the one or more nosepieces within its captured field of view is the recommended nosepiece. An indicator and/or instruction can be output accordingly. For example, in accordance with a determination that the recommended nosepiece is not installed (and/or that the recommended nosepiece is detected), the electronic device 500 can output the indicator 564 and/or the instruction 562 with respect to the recommended nosepiece. By further example, in accordance with a determination that the recommended nosepiece is installed, the electronic device 500 can forgo output of the indicator 564 and/or the instruction 562 with respect to the recommended nosepiece and/or provide a different output. By further example, in accordance with a determination that the recommended nosepiece is not detected, the electronic device 500 can output an indicator and/or an instruction with respect to the recommended nosepiece (and/or that none of the detected nosepieces is the recommended nosepiece).

In some embodiments, the user interface 544 can include one or more guides for assisting one or more users during adjustment and/or assembly with respect to a nosepiece. As shown in FIG. 11, the indicator 564 and/or the instruction 562 can indicate to a user a recommended configuration of one of multiple nosepieces (e.g., 400A, 400B, and/or 400C). In some embodiments, the electronic device 500, based on the determination of a recommended nosepiece configuration (e.g., based on one or more detections and/or measurements of a head and/or an eyewear device), can identify whether the selected nosepiece is in the recommended nosepiece configuration (e.g., providing the recommended nosepiece dimension). An indicator and/or instruction can be output accordingly (e.g., whether or not to adjust the selected nosepiece to a different configuration). For example, in accordance with a determination that the nosepiece is not in the recommended nosepiece configuration, the electronic device 500 can output the indicator 564 and/or the instruction 562 with respect to the recommended nosepiece configuration. By further example, in accordance with a determination that the nosepiece is in the recommended nosepiece configuration, the electronic device 500 can forgo output of the indicator 564 and/or the instruction 562 with respect to the recommended nosepiece configuration and/or provide a different output. It will be understood that such steps can be performed whether or not the nosepiece is installed on the head-mountable device.

In some embodiments, the user interface 544 can include one or more guides for assisting one or more users during adjustment and/or assembly with respect to a head engager. As shown in FIG. 11, the indicator 566 and/or the instruction 562 can indicate to a user a recommended configuration of one or more portions (e.g., arms 310) of a head engager. In some embodiments, the electronic device 500, based on the determination of a recommended arm configuration (e.g., based on one or more detections and/or measurements of a head and/or an eyewear device), can identify whether the one or more arms 310 (e.g., relative to end portions, bands, etc.) are in the recommended arm configuration (e.g., providing the recommended arm dimension). An indicator and/or instruction can be output accordingly (e.g., whether or not to adjust one or more arms 310 to a different configuration). For example, in accordance with a determination that the head engager (e.g., including one or more arms 310) is not in the recommended arm configuration, the electronic device 500 can output the indicator 566 and/or the instruction 562 with respect to the recommended arm configuration. By further example, in accordance with a determination that the head engager (e.g., including one or more arms 310) is in the recommended arm configuration, the electronic device 500 can forgo output of the indicator 566 and/or the instruction 562 with respect to the recommended arm configuration and/or provide a different output.

In some embodiments, the user interface 544 can include one or more guides for assisting one or more users during selection and/or assembly with respect to a frame. Where one or more frames are captured within a field of view of the electronic device 500, an indicator and/or an instruction can be provided with respect to a recommended frame for assembly with the head-mountable device 100. In some embodiments, the electronic device 500, based on the determination of which frame is a recommended frame (e.g., based on one or more detections and/or measurements of a head and/or an eyewear device), can identify whether one of the one or more frames within its captured field of view is the recommended frame. An indicator and/or instruction can be output accordingly. For example, in accordance with a determination that the recommended frame is not installed (and/or that the recommended frame is detected), the electronic device 500 can output the indicator and/or the instruction with respect to the recommended frame. By further example, in accordance with a determination that the recommended frame is installed, the electronic device 500 can forgo output of the indicator and/or the instruction with respect to the recommended frame and/or provide a different output. By further example, in accordance with a determination that the recommended frame is not detected, the electronic device 500 can output an indicator and/or an instruction with respect to the recommended frame (and/or that none of the detected frames is the recommended frame).

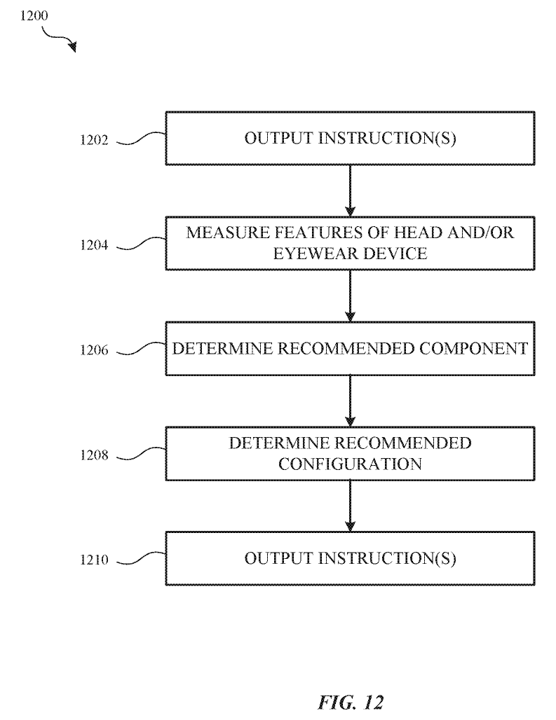

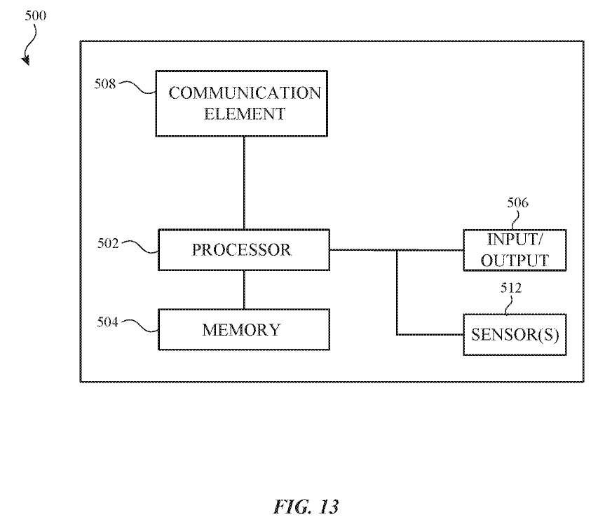

FIG. 12 illustrates a flow diagram of an example process 1200 for determining a recommended component, assembly, and/or adjustment of a head-mountable device. For explanatory purposes, the process 1200 is primarily described herein with reference to the electronic device 500. However, the process 1200 is not limited to the electronic device 500, and one or more blocks (or operations) of the process 1200 may be performed by different components of the head-mountable device and/or one or more other devices. Further for explanatory purposes, the blocks of the process 1200 are described herein as occurring in serial, or linearly. However, multiple blocks of the process 1200 may occur in parallel. In addition, the blocks of the process 1200 need not be performed in the order shown and/or one or more blocks of the process 1200 need not be performed and/or can be replaced by other operations.

The process 1200 can begin when the electronic device initiates a procedure for detecting a head of a user to measure features thereof (1202). Such a detection can be made by one or more sensors of the electronic device. Additionally or alternatively, the detection can be performed in response to an operational state of the electronic device (e.g., on/off state, application launch, user input command, and the like). An electronic device can provide a user interface and/or one or more instructions and/or indications to a user operating the electronic device (e.g., as shown in FIG. 4). The one or more instructions and/or indications can guide a user while the electronic device makes one or more measurements and/or detections.

The electronic device detects a head of a user to measure features thereof (1204). Such a detection can be made by one or more sensors of the electronic device. In some embodiments, a sensor of the electronic device can measure one or more distances to one or more regions of the head. Such regions can include one or both temples, one or both ears, a nose, and/or one or both eyes of the user. In some embodiments, a sensor of the electronic device can measure one or more distances to one or more regions of an eyewear device. Such regions can include a frame (e.g., including a nosepiece) and/or one or both arms. It should be understood that such measurements and/or detections can be made simultaneously and/or at different times. It should be understood that the features of the head can be detected and/or measured with and/or without the eyewear device. It should be understood that the features of the eyewear device can be detected and/or measured while on the head and/or while not on the head. Any combinations of measurements and/or detections can be made to determine recommended selections and/or configurations of a head-mountable device.

Based on the measured distances and/or the detected features, the electronic device and/or another device can determine a recommended component for a head-mountable device (1206). For example, a limited number of nosepieces and/or frames can be available with a variety of known shapes and sizes. Certain features, such as nose size and/or face shape of a user, can be used to determine the recommended selection from among the available nosepieces for assembly. Certain features, such as interpupillary distance and/or vision correction needs of a user, can be used to determine the recommended frame from among the available frames for assembly. It will be understood that the available frames and/or nosepieces can be prefabricated with respective dimensions and/or ranges of adjustability.

Based on the measured distances and/or the detected features, the electronic device and/or another device can determine a recommended configuration for one or more adjustable components of a head-mountable device (1208). For example, an adjustable nosepiece in a current configuration can be compared to a recommended nosepiece configuration to determine whether an adjustment is recommended. By further example, an adjustable head engager (e.g., including one or more arms) in a current configuration can be compared to a recommended arm configuration to determine whether an adjustment is recommended.

Based on the recommended frame, the recommended nosepiece, the recommended nosepiece configuration, and/or the recommended arm configuration, the electronic device and/or another device can provide instructions for assembly and/or adjustment of the head-mountable device (1210). Specifically, the instructions can include an indication of the recommended frame, the recommended nosepiece, the recommended nosepiece configuration, and/or the recommended arm configuration. The output can be included in a user interface including a captured view of one or more components of the head-mountable device (e.g., as shown in FIG. 11). The output can be based on one or more detections of one or more components and/or a current configuration thereof.

Referring now to FIG. 13, components of the electronic device can be provided and operatively connected to achieve the performance described herein. FIG. 13 shows a simplified block diagram of an electronic device 500 in accordance with one or more embodiments of the disclosure. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The electronic device 500 may include, among other components, a processor 502, a memory 504, one or more input/output devices 506, a communication element 508, and/or one or more sensors 512.

The processor 502, which may also be referred to as an application processor or a processor, may include suitable logic, circuitry, and/or code that enable processing data and/or controlling operations of the electronic device 500. In this regard, the processor 502 may be enabled to provide control signals to various other components of the electronic device 500. The processor 502 may also control transfers of data between various portions of the electronic device 500. Additionally, the processor 502 may enable implementation of an operating system or otherwise execute code to manage operations of the electronic device 500. The memory 504 may include suitable logic, circuitry, and/or code that enable storage of various types of information such as received data, generated data, code, and/or configuration information. The memory 504 may include, for example, random access memory (RAM), read-only memory (ROM), flash, and/or magnetic storage.

The input/output devices 506 can include any suitable component for providing interaction with a user and/or another device. The input/output devices 506 can include one or more buttons, keys, microphones, cameras, and the like. The input/output devices 506 can one or more displays, speakers, haptic feedback devices, and the like.

The communication element 508 may include suitable logic, circuitry, and/or code that enables wired or wireless communication. The communication element 508 of any given device can providing a communication link with the communication element of any other device. Such communication can be direct or indirect (e.g., through an intermediary). The communication element 508 may include, for example, one or more of a Bluetooth communication element, an NFC interface, a Zigbee communication element, a WLAN communication element, a USB communication element, or generally any communication element.

The one or more sensors 512 may include, for example, one or more image sensors, one or more depth sensors, one or more infrared sensors, one or more thermal (e.g., infrared) sensors, and/or generally any sensors that may be used to detect and/or measure features of a head of a user, features of an eyewear device, and/or features of a head-mountable device.

Accordingly, embodiments of the present disclosure provide a head-mountable device with custom components that are assembled to provide a variety of dimensions (e.g., sizes and shapes) for accommodating different users at different times. By detecting head features of a user and/or an eyewear device, a custom assembly for a head-mountable device can be determined to achieve a preferred fit. The custom assembly can be based on a range of available components and/or adjustable configurations thereof.

Various examples of aspects of the disclosure are described below as clauses for convenience. These are provided as examples, and do not limit the subject technology.

Clause A: an electronic device comprising: a sensor configured to detect one or more features of a head; and a processor configured to, in response to one or more detections of the one or more features of the head: determine a recommended nosepiece configuration of a head-mountable device from multiple nosepiece configurations having respective nosepiece dimensions that are different from each other; determine a recommended arm configuration of the head-mountable device from multiple arm configurations having respective arm dimensions that are different from each other; and provide an output including instructions to provide the head-mountable device with the recommended nosepiece configuration and the recommended arm configuration.

Clause B: an electronic device comprising: a sensor configured to measure distances from the sensor to one or more features of an eyewear device; and a processor configured to, in response to one or more detections of the one or more features of the eyewear device: determine a recommended nosepiece configuration of a head-mountable device from multiple nosepiece configurations having respective nosepiece dimensions that are different from each other; determine a recommended arm configuration of the head-mountable device from multiple arm configurations having respective arm dimensions that are different from each other; and provide an output including instructions to provide the head-mountable device with the recommended nosepiece configuration and the recommended arm configuration.

Clause C: a head-mountable device comprising: a frame; a head engager including: a pair of arms extending from opposing sides of the frame; and a pair of end portions each adjustably coupled to a respective one of the arms and arranged in one of multiple arm configurations relative to the respective one of the arms, the multiple arm configurations having respective arm dimensions that are different from each other; and multiple nosepieces having respective nosepiece dimensions that are different from each other, wherein the frame is configured to releasably engage a selected one of the multiple nosepieces.

One or more of the above clauses can include one or more of the features described below. It is noted that any of the following clauses may be combined in any combination with each other, and placed into a respective independent clause, e.g., Clause A, B, or C.

Clause 1: the sensor is configured to detect the one or more features of the head by detecting: a distance to a temple of the head; a distance to an ear of the head; and a distance to a nose of the head; the recommended nosepiece configuration has a nosepiece dimension corresponding to the distance to the nose; and the recommended arm configuration has an arm dimension corresponding to the distance to the temple and the distance to the ear.

Clause 2: the processor is further configured to determine the recommended nosepiece configuration by selecting from multiple nosepieces having the respective nosepiece dimensions that are different from each other.

Clause 3: the processor is further configured to determine the recommended nosepiece configuration by selecting from the multiple nosepiece configurations of an adjustable nosepiece, the multiple nosepiece configurations having the respective nosepiece dimensions that are different from each other.

Clause 4: the processor is further configured to determine the recommended arm configuration by selecting from the multiple arm configurations of one or more adjustable arms of the head-mountable device, the multiple arm configurations having the respective arm dimensions that are different from each other.

Clause 5: the processor is further configured to, in response to the one or more detections of the one or more features of the head, determine a recommended frame from multiple frames having respective display separation distances that are different from each other, wherein the output includes an instruction to provide the recommended frame with a recommended one of the display separation distances.

Clause 6: the sensor is configured to detect one or more features of an eyewear device; and the processor is further configured to: determine the recommended nosepiece configuration further in response to one or more detections of the eyewear device; and determine the recommended arm configuration further in response to one or more detections of the eyewear device.

Clause 7: a camera; a display, wherein the processor is further configured to provide the output by: capturing an image of the head-mountable device; and displaying a user interface with the image of the head-mountable device with an indication of the recommended nosepiece configuration and an indication of the recommended arm configuration.

Clause 8: the sensor includes a depth sensor, an image sensor, or an infrared sensor.

Clause 9: an electronic device comprising: a sensor configured to measure distances from the sensor to one or more features of an eyewear device; and a processor configured to, in response to one or more detections of the one or more features of the eyewear device: determine a recommended nosepiece configuration of a head-mountable device from multiple nosepiece configurations having respective nosepiece dimensions that are different from each other; determine a recommended arm configuration of the head-mountable device from multiple arm configurations having respective arm dimensions that are different from each other; and provide an output including instructions to provide the head-mountable device with the recommended nosepiece configuration and the recommended arm configuration.

Clause 10: the sensor is configured to detect the one or more features of the eyewear device by detecting: a distance to each of a pair of nose engagement portions of the eyewear device; and a distance to each of a pair of arms of the eyewear device; the recommended nosepiece configuration has a nosepiece dimension corresponding to the distance to each of the pair of nose engagement portions; and the recommended arm configuration has an arm dimension corresponding to the distance to the distance to each of the pair of arms of the eyewear device.

Clause 11: the sensor is configured to detect the one or more features of the eyewear device by detecting: a first set of one or more distances to the one or more features of the eyewear device while the eyewear device is worn on a head; and a second set of one or more distances to the one or more features of the eyewear device while the eyewear device is not worn on the head; and the recommended arm configuration is determined based on a difference between the first set of one or more distances and the second set of one or more distances.

Clause 12: the processor is further configured to, in response to the one or more detections of the one or more features of the eyewear device, determine a recommended frame from multiple frames having respective display separation distances that are different from each other, wherein the output includes an instruction to provide the recommended frame with a recommended one of the display separation distances.

Clause 13: each of the multiple nosepieces is adjustable to alter a separation distance between respective nose engagement portions of a respective nosepiece.

Clause 14: each of the multiple nosepieces is adjustable to alter an angle between respective nose engagement portions of a respective nosepiece.

As described above, one aspect of the present technology may include the gathering and use of data available from various sources. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user’s health or level of fitness (e.g., vital signs measurements, medication information, exercise information), date of birth, or any other identifying or personal information.

The present disclosure recognizes that the use of such personal information data, in the present technology, can be used to the benefit of users. For instance, health and fitness data may be used to provide insights into a user’s general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user’s privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

In contrast, a computer-generated reality (CGR) environment refers to a wholly or partially simulated environment that people sense and/or interact with via an electronic system. In CGR, a subset of a person’s physical motions, or representations thereof, are tracked, and, in response, one or more characteristics of one or more virtual objects simulated in the CGR environment are adjusted in a manner that comports with at least one law of physics. For example, a CGR system may detect a person’s head turning and, in response, adjust graphical content and an acoustic field presented to the person in a manner similar to how such views and sounds would change in a physical environment. In some situations, (e.g., for accessibility reasons), adjustments to characteristic(s) of virtual object(s) in a CGR environment may be made in response to representations of physical motions (e.g., vocal commands).

A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects.

Examples of CGR include virtual reality and mixed reality.

A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person’s presence within the computer-generated environment, and/or through a simulation of a subset of the person’s physical movements within the computer-generated environment.

In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end.

In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground.

Examples of mixed realities include augmented reality and augmented virtuality.

An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment.

An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

An augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

There are many different types of electronic systems that enable a person to sense and/or interact with various CGR environments. Examples include head-mountable systems, projection-based systems, heads-up displays (HUDs), vehicle windshields having integrated display capability, windows having integrated display capability, displays formed as lenses designed to be placed on a person’s eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person’s eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person’s retina. Projection systems also may be configured to project virtual objects into the physical environment, for example, as a hologram or on a physical surface.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. An electronic device comprising:
a sensor configured to detect one or more features of a head; and
a processor configured to, in response to one or more detections of the one or more features of the head:
determine a recommended nosepiece configuration of a head-mountable device from multiple nosepiece configurations having respective nosepiece dimensions that are different from each other;
determine a recommended arm configuration of the head-mountable device from multiple arm configurations having respective arm dimensions that are different from each other; and
provide an output including instructions to provide the head-mountable device with the recommended nosepiece configuration and the recommended arm configuration.

2. The electronic device of claim 1, wherein:
the sensor is configured to detect the one or more features of the head by detecting:
a distance to a temple of the head;
a distance to an ear of the head; and
a distance to a nose of the head;
the recommended nosepiece configuration has a nosepiece dimension corresponding to the distance to the nose; and
the recommended arm configuration has an arm dimension corresponding to the distance to the temple and the distance to the ear.

3. The electronic device of claim 1, wherein the processor is further configured to determine the recommended nosepiece configuration by selecting from multiple nosepieces having the respective nosepiece dimensions that are different from each other.

4. The electronic device of claim 1, wherein the processor is further configured to determine the recommended nosepiece configuration by selecting from the multiple nosepiece configurations of an adjustable nosepiece, the multiple nosepiece configurations having the respective nosepiece dimensions that are different from each other.

5. The electronic device of claim 1, wherein the processor is further configured to determine the recommended arm configuration by selecting from the multiple arm configurations of one or more adjustable arms of the head-mountable device, the multiple arm configurations having the respective arm dimensions that are different from each other.

6. The electronic device of claim 1, wherein the processor is further configured to, in response to the one or more detections of the one or more features of the head, determine a recommended frame from multiple frames having respective display separation distances that are different from each other, wherein the output includes an instruction to provide the recommended frame with a recommended one of the display separation distances.

7. The electronic device of claim 1, wherein:
the sensor is configured to detect one or more features of an eyewear device; and
the processor is further configured to:
determine the recommended nosepiece configuration further in response to one or more detections of the eyewear device; and
determine the recommended arm configuration further in response to the one or more detections of the eyewear device.

8. The electronic device of claim 1, further comprising:
a camera;
a display,
wherein the processor is further configured to provide the output by:
capturing an image of the head-mountable device; and
displaying a user interface with the image of the head-mountable device with an indication of the recommended nosepiece configuration and an indication of the recommended arm configuration.

9. The electronic device of claim 1, wherein the sensor includes a depth sensor, an image sensor, or an infrared sensor.

10. An electronic device comprising:
a sensor configured to measure distances from the sensor to one or more features of an eyewear device; and
a processor configured to, in response to one or more detections of the one or more features of the eyewear device:
determine a recommended nosepiece configuration of a head-mountable device from multiple nosepiece configurations having respective nosepiece dimensions that are different from each other;
determine a recommended arm configuration of the head-mountable device from multiple arm configurations having respective arm dimensions that are different from each other; and
provide an output including instructions to provide the head-mountable device with the recommended nosepiece configuration and the recommended arm configuration.

11. The electronic device of claim 10, wherein:
the sensor is configured to detect the one or more features of the eyewear device by detecting:
a distance to each of a pair of nose engagement portions of the eyewear device; and
a distance to each of a pair of arms of the eyewear device;
the recommended nosepiece configuration has a nosepiece dimension corresponding to the distance to each of the pair of nose engagement portions; and
the recommended arm configuration has an arm dimension corresponding to the distance to the distance to each of the pair of arms of the eyewear device.

12. The electronic device of claim 10, wherein:
the sensor is configured to detect the one or more features of the eyewear device by detecting:
a first set of one or more distances to the one or more features of the eyewear device while the eyewear device is worn on a head; and
a second set of one or more distances to the one or more features of the eyewear device while the eyewear device is not worn on the head; and
the recommended arm configuration is determined based on a difference between the first set of one or more distances and the second set of one or more distances.

13. The electronic device of claim 10, wherein the processor is further configured to determine the recommended nosepiece configuration by selecting from multiple nosepieces having the respective nosepiece dimensions that are different from each other.

14. The electronic device of claim 10, wherein the processor is further configured to determine the recommended nosepiece configuration by selecting from the multiple nosepiece configurations of an adjustable nosepiece, the multiple nosepiece configurations having the respective nosepiece dimensions that are different from each other.

15. The electronic device of claim 10, wherein the processor is further configured to determine the recommended arm configuration by selecting from the multiple arm configurations of one or more adjustable arms of the head-mountable device, the multiple arm configurations having the respective arm dimensions that are different from each other.

16. The electronic device of claim 10, wherein the processor is further configured to, in response to the one or more detections of the one or more features of the eyewear device, determine a recommended frame from multiple frames having respective display separation distances that are different from each other, wherein the output includes an instruction to provide the recommended frame with a recommended one of the display separation distances.

17. The electronic device of claim 10, further comprising:
a camera;
a display,
wherein the processor is configured to provide the output by:
capturing an image of the head-mountable device; and
displaying a user interface with the image of the head-mountable device with an indication of the recommended nosepiece configuration and an indication of the recommended arm configuration.

18. A method comprising:
detecting one or more features of a head; and
in response to one or more detections of the one or more features of the head:
determine a recommended nosepiece configuration of a head-mountable device from multiple nosepiece configurations having respective nosepiece dimensions that are different from each other;
determine a recommended arm configuration of the head-mountable device from multiple arm configurations having respective arm dimensions that are different from each other; and
provide an output including instructions to provide the head-mountable device with the recommended nosepiece configuration and the recommended arm configuration.

19. The method of claim 18, further comprising:
detecting one or more features of an eyewear device, wherein:
determining the recommended nosepiece configuration is further in response to one or more detections of the eyewear device; and
determining the recommended arm configuration is further in response to the one or more detections of the eyewear device.

20. The method of claim 18, wherein providing the output includes:
capturing an image of the head-mountable device; and
displaying a user interface with the image of the head-mountable device with an indication of the recommended nosepiece configuration and an indication of the recommended arm configuration.
